(19) United States
(12) Patent Application Publication
(10) Pub. No.: US 2011/0301974 A1
(43) Pub. Date: Dec. 8, 2011

(54) Adaptive Intervention and Management Method for Healthcare Organizations

(76) Inventors: Jay Shiro Tashiro, Tucson, AZ (US); Robert Tashiro, Chicago, IL (US); Jessica Alvarado-Yule, Tucson, AZ (US)

(21) Appl. No.: 13/210,294

(22) Filed: Aug. 15, 2011

Related U.S. Application Data
(63) Continuation of application No. 12/122,604, filed on May 16, 2008.
(60) Provisional application No. 60/938,682, filed on May 17, 2007.

(51) Int. Cl. G06Q 50/00; G06Q 10/00

(52) U.S. Cl. 705/2

(57) ABSTRACT

A method to optimize the performance of a health care organization, comprising creating a 3-dimensional Healthcare Adaptive Cycle space defined by a Potential axis, a Connectedness axis, and a Resilience axis. The method then determines at a first evaluation time a first location for the healthcare organization within said Healthcare Adaptive Cycle, and visually displays the 3-dimensional Healthcare Adaptive Cycle space and the first location.

### CROSS-REFERENCE TO RELATED APPLICATIONS

This Application is a Continuation Application of the U.S. non-provisional application having Ser. No. 12/122,604 filed on May 16, 2008, which claimed priority from a U.S. Provisional Application having Ser. No. 60/938,682 filed May 17, 2007, all of which are incorporated by reference herein.

### FIELD OF THE INVENTION

The present invention relates generally to managing healthcare organizations and more particularly to optimizing the performance of a health care system healthcare organizations, and its nested subsystems.

### BACKGROUND OF THE INVENTION

In today's healthcare organizations, worldwide, management strategies are not driven by processes that sample broadly or deeply within the levels or subsystems of the system. This is true across the spectrum of healthcare organizations, including systems in the United States such as individual hospitals, clusters of hospitals under health management organizations, outpatient clinics, primary care practices, and assisted living centers, but also the healthcare planning and delivery agencies such as the Local Health Integration Networks in Canada.

A partial exception to lack of data-driven management may occur at the healthcare level of direct care of patients, which is more closely monitored and data-driven, and where the consequences for failure are more immediately evident and often disastrous. However, even at the level of direct patient care, there has been an increasing call for evidence-based practice. It is clear that evidence-based practice has been difficult to implement because of the multivariate nature of human physiological and psychosocial systems, compounded by the multivariate nature of healthcare interventions for any particular disease or injury state.

Even if most healthcare organizations maintain a relatively stable quality of direct patient care, close inspection of higher levels within healthcare organizations reveal increasing loss of resolution regarding data critical for empirically driven management of the system as a whole. Part of the problem is that there are multiple equilibria of the larger system or some of its subsystems that can yield the same quality of patient care. Indeed, it is possible to have multiple equilibria that yield not only the same quality of patient care but also what appears to be a reasonable management strategy and financial stability.

However, managers of healthcare organizations are often surprised by a relatively sudden shift that reveals the system is not doing as well as the strategists and stakeholders had assumed. Usually, such a revelation results when the strategists did not really understand the behavior of the critical variables defining the equilibrium in which the system was located. In brief, the strategists usually do not know in which of several possible equilibria a healthcare organization or subsystem actually exists. Furthermore, they usually do not know that some of the possible equilibria are less stable than others or are metastable and likely to move along a trajectory that was not within the projected strategic framework of the healthcare organization.

A second part of the problem is that, like natural ecosystems, healthcare organizations are subject to both temporal and spatial heterogeneity. For example, patient censuses and staffing turnover may change through time (temporal variation) and may differentially impact different levels or subsystems of the system (spatial heterogeneity). Adequate sampling becomes extremely important in order to assess spatial and temporal heterogeneity of the critical variables essential to data-driven management of a healthcare organization or the different levels within that system. Certainly, a number of business intelligence systems, consulting methodologies, data mining applications, and other analytical systems, attempt to identify the positions of stability in which a healthcare organization resides at one moment in time. However, these systems seldom conduct adequate sampling at any one time, let alone along the time series that would provide sufficient information to portray the likely impacts of temporal and spatial variability within a system's various levels or subsystems.

A third part of the problem has been the lack of a theoretical framework that drives an interpretive framework for data collection and analysis. For example, even if the second problem described above can be addressed, current business intelligence systems, consulting methodologies, data mining applications, and other analytical systems, have not captured the breadth and depth of temporal and spatial heterogeneity that occurs in most healthcare organizations, and contextualized such variability within meaningful management frameworks that allow ongoing intervention for enhanced continuous quality improvement.

It should be apparent from the foregoing that the three parts of the problem and inadequacies of the prior art contribute to a general failure to collect sufficient and high quality data on systems, wherein the interpretation of that data can enhance the management of healthcare organizations, and moving sensibly towards systems empirically founded on evidence-based practice. Thus, it is impossible to analyze the trajectories of the critical variables that shape any temporary equilibrium in a healthcare organization that would contribute to a shift of the equilibrium to another position. The consequence is that some quality of patient care is sustained but there is little overall knowledge of the particular suite of equilibria around which the system and its subsystems are interacting through time and within the various spatial elements (i.e., levels, units, or subsystems) of the system.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates a 3-dimensional space comprising Applicants' Healthcare Adaptive Cycle;

FIG. 2 is a bloc diagram showing the three major components of the Applicants' method;

FIG. 3 comprises FIGS. 3A, 3B, and 3C, and is a flow chart summarizing the steps of one embodiment of Applicants' method;

FIG. 4 comprises FIGS. 4A and 4B, and illustrates Applicants' Data Acquisition Subsystem;

FIG. 5 comprises FIGS. 5A and 5B, and illustrates the steps of Applicants' Adaptive Cycle Interpretive Framework and articulation with the Interpretive Dashboard System;

FIG. 6 shows the hardware configuration and interoperability for one embodiment of the invention;

FIG. 7 graphically illustrates changes over time of a healthcare organization's position within the K space for Applicants' Healthcare Adaptive Cycle;

FIG. 8 depicts using microanalyses to identify changes over time of a healthcare organization's position within Applicants' Healthcare Adaptive Cycle;

FIG. 9 graphically illustrates how Applicants' Healthcare Adaptive Cycle can identify actual and preferred directions for change within Applicants' Healthcare Adaptive Cycle;

FIG. 10 shows variable clusters and how these can displayed by the Interpretive Dashboard Subsystem; and

FIG. 11 shows a dashboard portraying values in a variable cluster for the Adaptive Cycle dimension of Potential dimension of Applicants' Healthcare Adaptive Cycle.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Applicants' method is described and claimed herein as implemented in healthcare organizations. This description should not be taken as limiting. Rather, Applicants' method can be utilized by diverse types of organizations, including but not limited to educational organizations, community service organizations, business organizations, and the like.

Recognizing a chronic under-sampling of variables that are critical for analyses leading to effective management of healthcare organizations, Applicants' invention provides a computer-implemented method that: (1) allows a healthcare organization to select an organizational level or unit for analysis, and choose an intensity of sampling; and (2) collects data, analyzes that data, and provides as output a set of recommendations for delineating and implementing strategic goals for that system.

The different levels or units of organization that can be sampled and analyzed by Applicants' method range from macro to micro, that is, from macro institutional or multi-institutional levels to micro levels of individual perceptions. Such sampling is accomplished by direct input from individuals or from databases or data depositories within a healthcare organization, at whatever unit is designated as the object of analysis.

The present invention comprises an adaptive intervention management method for health care systems. Applicants' method addresses the aforementioned inadequacies of prior art by providing a sampling and analytical tool for quantifying a health system's position within an interpretive framework called an “Adaptive Cycle.”

Applicants' method can be tailored to provide adaptive intervention management for any level or subsystem of a healthcare organization. For convenience and clarity, we will use the term healthcare organization for a healthcare organization and units to broadly represent the levels of subsystems of the healthcare organization. The healthcare organization as a whole and its units can be conceptualized within the three dimensions of an Adaptive Cycle. These dimensions are: Potential, Connectedness, and Resilience.

Values for the three dimensions can be calculated from data sampled from a healthcare organization or any subsystem. For example, at any moment in time, a value for the Potential of a healthcare organization or its units can be defined and quantitatively measured by variables related to Potential that are specific to an organization or units of an organization. Analogously, values for Connectedness and Resilience can be defined and quantitatively measured by variables that are specific to these respective dimensions within a healthcare organization or its units.

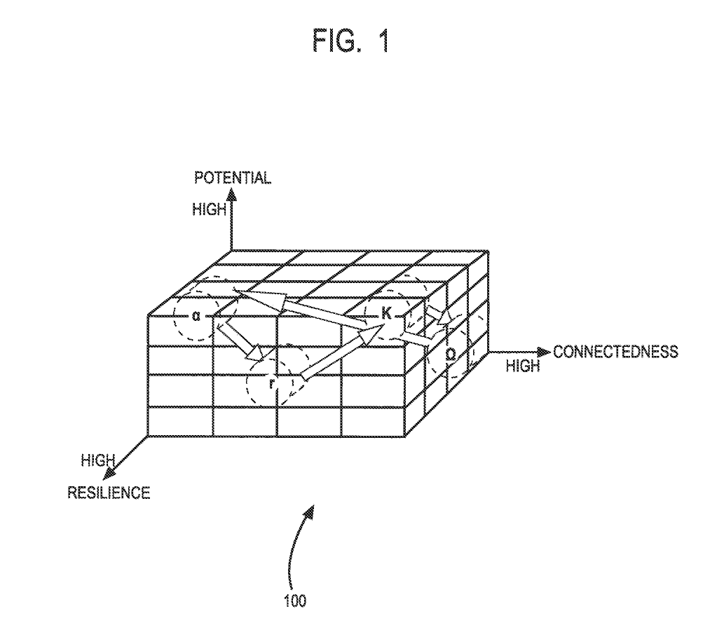

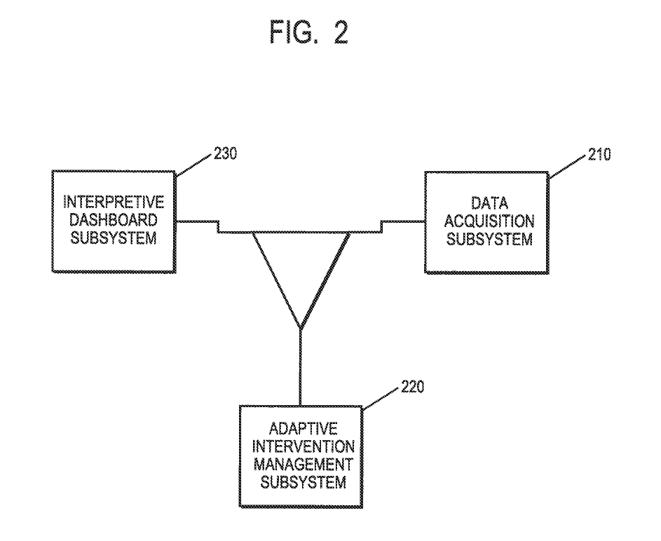

FIG. 1 illustrates a three-dimensional space 100 in which Applicants' Healthcare Adaptive Cycle resides. The three dimensions define a space comprising the four aforedescribed regions of K, Ω, α, and r, as well as areas of transition from one of these regions to another. These four regions represent different combinations of values for Potential, Connectedness, and Resilience within the three-dimensional space. These different regions of Applicants' Healthcare Adaptive Cycle have very specific characteristics, and they each represent different combinations of values for Potential, Connectedness, and Resilience within the three-dimensional space.
K.—The K region is more typically one in which variability is controlled, with increasing efficiency, streamlined operations, and improving connections within a system. Potential and Connectedness are high while Resilience is decreased.
Ω.—As Connectedness leads to rigidity, accumulated resources can be released from controlled and sequestered compartments or subsystems. Connections within the system become weakened and feedback regulatory controls can become weakened. The organization or some of its units may be collapsing in this region. Potential and Resilience are decreased while Connectedness is high.
α.—This is a region typified by reorganization that can lead to subsequent growth and resource accumulation. Resilience and Potential is generally high, while Connectedness is low. This region has the most uncertainty.
r.—In the r region, there is considerable external variability impacting a system. Resilience is relatively high, while Potential and Connectedness are low.
Ω to α.—This “backloop” transition zone from the Ω region to the α region can be seen as a sudden and often dramatic increase in uncertainty, with many chaotic elements.
r to K.—The “front loop” transition zone from the r region to K region is typified by a period in which short-term predictability increases. Resources are accumulated and connections with in the system increase and so increase efficiency.

One embodiment of Applicants' method comprises a network-based service that provides users with a specific implementation for a healthcare organization (a hospital, HMO, hospital cluster, and the like). This embodiment utilizes Applicants' Healthcare Adaptive Cycle and provides data-driven decisions for management and ongoing quality improvement. Such decisions emerge because Applicants' method quantifies a healthcare organization's location within Applicants' Healthcare Adaptive Cycle.

FIG. 2 illustrates the three subsystems of Applicants' method, the Adaptive Intervention Management Subsystem 220, the Data Acquisition Subsystem 210, and the Interpretive Dashboard Subsystem 230. User group members function as an Instance Administrator who provides data on the healthcare organization or one of its units, a Healthcare Manager who provides strategic guidance for continuous quality improvement, and/or individuals within the organization who provide data input from their respective units.

Applicants' invention comprises computer readable program code encoding a series of data structures, such as and without limitation relational databases, flat files, HTML files, spreadsheet files, and the like, and user interfaces for sampling personnel or data depositories within a healthcare organization. Applicants' invention further comprises computer readable program code to analyze the collected data in order make data-driven decisions for effective management. The analytical algorithms include numerous types of statistical procedures that provide mapping and analyses of a health system's data within an Adaptive Cycle framework.

An Instance Administrator establishes Adaptive Cycle Parameters for the specific implementation. Using menus and relational databases, this subsystem defines the timing of data collection, sampling regimes, selection of variables, weighting of variable values, and types of Adaptive Cycle analyses appropriate to the implementation. Idiosyncrasies within a particular healthcare organization or its units are handled by adjusting certain Adaptive Cycle Parameters, such as for example sampling regimes and timing, that will be used to monitor the healthcare organizations or subsystems position within Applicants' Healthcare Adaptive Cycle, and to determine a location in one of the four regions defined by K, Ω, α, and r, or a location in a transition phase.

Applicants' method uses the Adaptive Cycle Parameters to activate the Data Acquisition Subsystem and instruct this subsystem with respect to patterns for data collection as well as what data should be collected. The Adaptive Management Subsystem also coordinates the Data Acquisition Subsystem and the Interpretive Dashboard Subsystem so that data are collected and analyzed by the Data Acquisition Subsystem and then displayed within an interpretive framework by the Interpretive Dashboard Subsystem.

TABLES 1-5 recites the types of queries used to create data collection tasks used in a specific implementation. These queries comprise a small sample that are displayed using a plurality of menus in Applicants' Adaptive Management System, and that could be selected by the Instance Administrator in consultation with Healthcare Managers to customize Applicants' method for the idiosyncrasies of their respective healthcare organization and subsystems.

TABLE 1
Variables Relating To Potential/Global

| | |
|---|---|
| 1. | Rank your ability to reach your potential as an individual within your organization |
| 2. | Rank your department's ability to reach your potential within your organization |
| 3. | Rank your organization's ability to reach its potential |
| 4. | Failure to reach your department potential results from? (processes, communication, |
| | direction, resources) |
| 5. | Failure to reach your organization's potential results from? (processes, communication, |
| | direction, resources) |
| 6. | Failure to reach your individual potential results from? (processes, communication, |
| | direction, resources, incentive, motivation, other conflict) |
| 7. | Is your individual potential articulated clearly and accessible for all at your level to |
| | discern? |
| 8. | Is your individual potential defined by objective measures (metrics, quantifiable goals, |
| | incentive plans, etc.)? |
| 9. | Is your department potential articulated clearly and accessible for all to discern? |
| 10. | Is your department potential defined by objective measures (metrics, quantifiable goals, |
| | incentive plans, etc.)? |
| 11. | Is your organization potential articulated clearly and accessible for all to discern? |
| 12. | Is your organization potential defined by objective measures (metrics, quantifiable goals, |
| | incentive plans, etc.)? |
| 13. | Are individual incentive plans aligned with department and organization goals/potential? |
| 14. | If your department potential is defined by objective measures, are these measures and |
| | the performance towards achievement reviewed on a consistent basis? |
| 15. | If the answer to the above question is yes, are definitive, action oriented plans put into |
| | place (and reviewed) consistently to ensure achievement? |

TABLE 2
Variables Relating To Potential/Business

| | |
|---|---|
| 1. | Is revenue meeting or exceeding budgeted revenue? |
| 2. | Is profit meeting or exceeding budgeted profit? |
| 3. | What is the percent of revenue associated with |
| | Medicare/Medicaid? |
| 4. | What is the percent of payments to gross revenue? |
| 5. | What is the percent of adjustments to gross revenue? |
| 6. | What is your unbilled A/R days (in-house AR measures)? |
| 7. | What is your budgeted DNFB days? |
| 8. | What is your actual DNFB days? |
| 9. | What is your budgeted number of days in coding? |
| 10. | What is your actual number of days in coding? |
| 11. | What is your budgeted A/R days? |
| 12. | What is your actual A/R days? |
| 13. | What is your number of claims produced? |
| 14. | What is the percent of edited claims vs. produced claims? |
| 15. | What is the percent of claims passed vs. produced claims? |
| 16. | What is your number of claims transmitted? |
| 17. | What is your number of “clean” claims transmitted? |
| 18. | What is number of claims that are backlogged? |
| 19. | What is your collection percentage for gross |
| | (payments/charges)? |
| 20. | What is your collection percentage for net |
| | (payments/charges-adjustments)? |

TABLE 3
Variables Relating To Potential/Clinical

| | |
|---|---|
| 1. | What is your nurse/patient ratio? |
| 2. | What is the percent of temporary nursing staff to employed nurses? |
| 3. | Is YTD Census meeting or exceeding budgeted Census? |
| 4. | What is the number of outpatient visits per year? |
| 5. | What is the number of emergency department encounters per year? |
| 6. | Are patients routinely turned away or delayed in receiving care due to staff shortages? |
| 7. | How many operative/post-operative errors and/or complications occurred in the past |
| | year? |
| 8. | How many falls occurred in the past year? |
| 9. | How many documentation errors occurred in the past year? |
| 10. | How many deficiencies in credentialing/privileges occurred in the past year? |
| 11. | How many transfusion errors occurred in the past year? |
| 12. | How many wrongful surgical procedures occurred in the past year? |
| 13. | Any infant abductions/release to wrong families occurred in the past year? |
| 14. | How many wrongful deaths occurred in the past year? |
| 15. | How many incomplete preoperative assessments occurred in the past year? |
| 16. | How many readmissions within a 24-hour discharge? |
| 17. | How many sentinel events occurred in the past year? |
| 18. | How many sentinel events resulted in a lawsuit against the organization? |
| 19. | How many improper dose or quantity was given to patients in the past year? |
| 20. | How many omissions occurred in the past year? |
| 21. | How many prescription errors occurred in the past year? |
| 22. | How many wrong time errors occurred in the past year? |
| 23. | How many wrong patient errors occurred in the past year? |
| 24. | How many wrong route errors occurred in the past year? |

TABLE 4
Variables Relating To Connectedness

| | |
|---|---|
| 1. | Do you feel “connected” to your peers within your department? |
| 2. | Do you feel “affiliated” with like peers from other departments? |
| 3. | Do you feel that there is a “team” effort in solving problems within your department? |
| 4. | Do you feel that there is a “team” effort in solving problems for the organization? |
| 5. | Are there Policy & Procedure manuals for each department? |
| 6. | Are the Policy & Procedure manuals easily accessible? |
| 7. | Are there department newsletters? |
| 8. | Is there an organization newsletter? |
| 9. | Is there a “willingness to help” culture within the department? |
| 10. | Is there a “willingness to help” culture throughout the organization? |
| 11. | Do you perceive artificial barriers when working with other departments? |
| 12. | How do you ask and receive help when doing your job? (no help, manual, co-worker, |
| | website/database, supervisor) |
| 13. | Do you understand the relationship of your workflow with other departments? |
| 14. | How do your daily responsibilities impact other departments? |
| 15. | How often do you hear from another department as to positive/negative impact from your |
| | daily work? |
| 16. | Do you feel your daily contributions make an impact to achieving the organization's |
| | goals? |
| 17. | Do you feel that your daily contributions make an impact to achieving the department's |
| | goals? |
| 18. | Do you enjoy a sense of pride with your department? |
| 19. | Do you enjoy a sense of pride with your organization? |
| 20. | Do you feel that your department is isolated in its job responsibilities? |
| 21. | Do you feel that you and your co-workers work in isolation? |
| 22. | Do you feel that there are artificial barriers between departments? |
| 23. | Do you perceive that people with the same job responsibilities are treated differently |
| | either as individuals or by given extra help, other responsibilities or allowed to cut corners |
| | with policy/procedure? |
| 24. | Are you given all of the pertinent information/access/databases to do your job |
| | responsibilities? |
| 25. | Are you required to generate your own reference materials for your responsibilities? |
| 26. | What percent of your reference materials for your job responsibilities is out of date? |
| 27. | How often do you socialize with your co-workers? |
| 28. | How often is there a planned social event where everyone from your department is |
| | invited? |
| 29. | What percent of people attend a planned social event for work? |
| 30. | How often is there a spontaneous social event with co-workers? |
| 31. | What percent of people attend a spontaneous social event? |
| 32. | How does your department share business/clinical goals? |
| 33. | How does your organization share business/clinical goals? |
| 34. | How often are the department business/clinical goals reviewed and discussed? |
| 35. | How often are your organization's business/clinical goals reviewed and discussed? |

TABLE 5
Variables Relating To Resilience

| | |
|---|---|
| 1. | How many supervisors has your department had during the past five years? |
| 2. | How many crises has your department had during the past five years? |
| 3. | Rate your department's recovery time from crises (>1 month, a week to a month, a few days) |
| 4. | How many CEOs have your organization had during the last 10 years? |
| 5. | How many major crises has your organization had during the past 10 years? |
| 6. | Rate your organization's recovery time from crises (>1 month, a week to a month, a few |
| | days). |

The entered data are analyzed for the point in time sampled, and combined to quantify values for Potential, Connectedness, and Resilience, wherein those values determine the system's present location within the Applicants' Healthcare Adaptive Cycle. In certain embodiments, the method statistically combines the variable values for each dimension into a measure of central tendency at a particular time and particular unit of the healthcare organization. These central tendencies represent an estimate of a value along the dimensions of Potential, Connectedness, and Resilience, thereby providing a triad of coordinates at the time sampled. These coordinates define a point in the three-dimensional space of Applicants' Healthcare Adaptive Cycle, falling within one of regions of K, Ω, α, and r or in regions of transition from one of these regions to another.

Sampling proceeds through time, and the trajectory of the healthcare organization or its units can be tracked and analyzed within Applicants' Adaptive Cycle. The DAS feeds data analyses and interpretations to the Interpretive Dashboard Subsystem (IDS). The IDS has the capacity to store and can display such analyses and interpretations.

A Healthcare Manager can then access the IDS and select a variety of dashboards to view the behavior of the healthcare organization or its subsystem within Applicants' Healthcare Adaptive Cycle. Such dashboards allow identification of changes in variables that are driving changes in the position of a healthcare organization and its units within the space of Applicants' Healthcare Adaptive Cycle. Understanding such changes and prediction of quality stasis, improvement, or deterioration provide a data-driven foundation for adaptive management of a healthcare organization or its units by allowing targeted adaptive intervention.

Applicants' method allows data to be timely and cost-effectively collected. These samplings are then evaluated using analyses selected by the healthcare organization stakeholders. Healthcare Managers can then identify the location of the system within Applicants' Adaptive Cycle at a moment in time, and how that system is changing through time. Applicants' method thereby overcomes sampling and analytical deficiencies as well as high costs of other decision-management tools for empirically derived management decisions in healthcare.

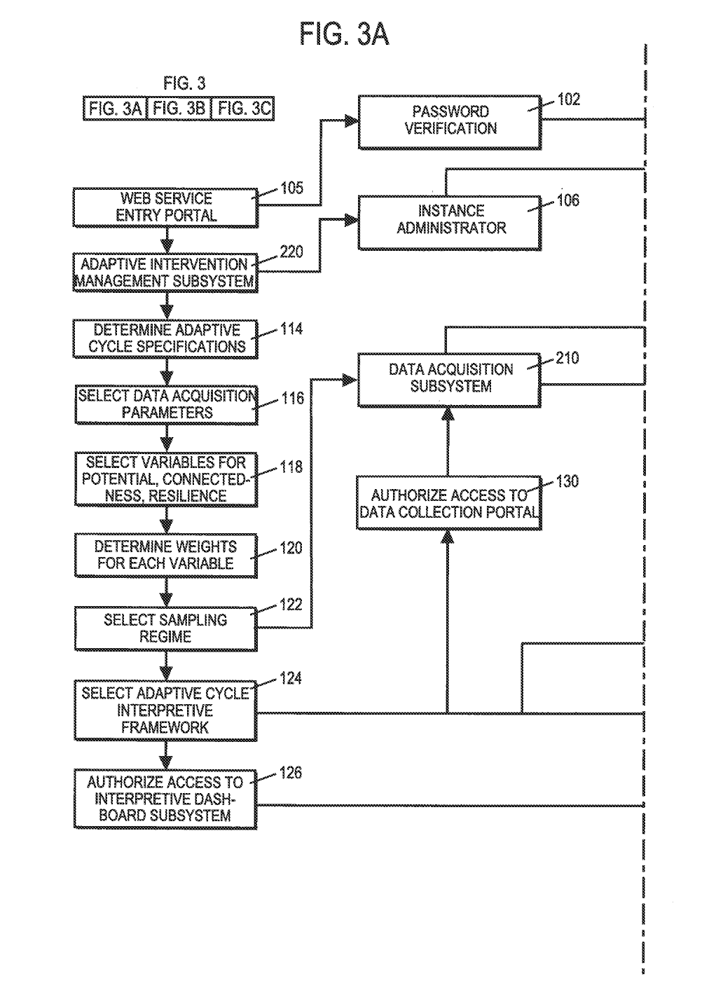

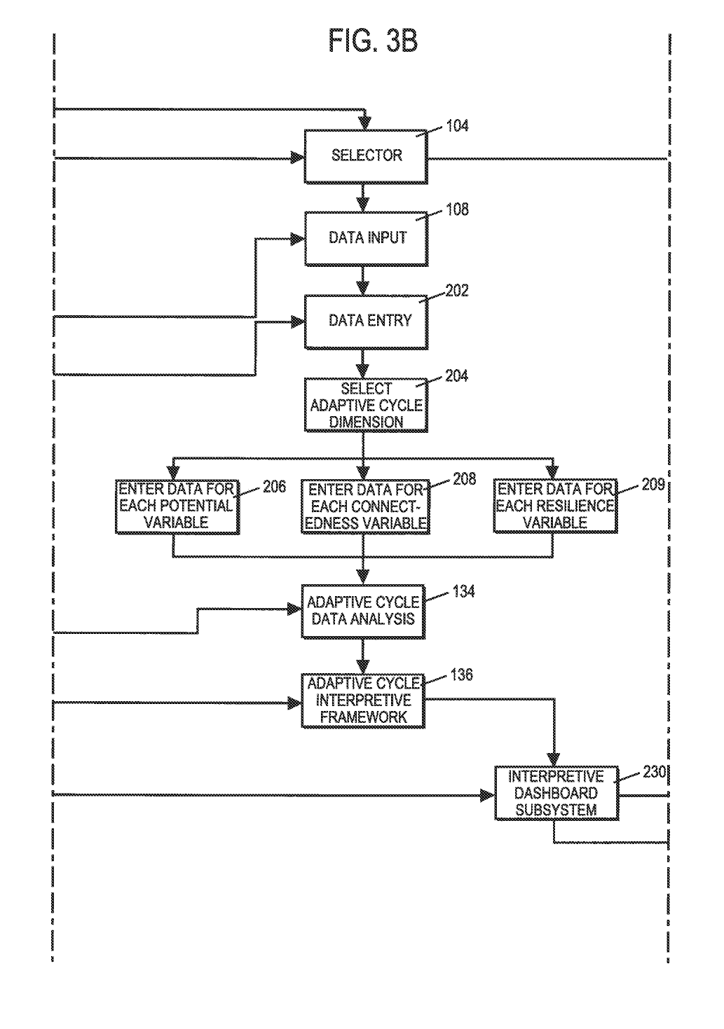

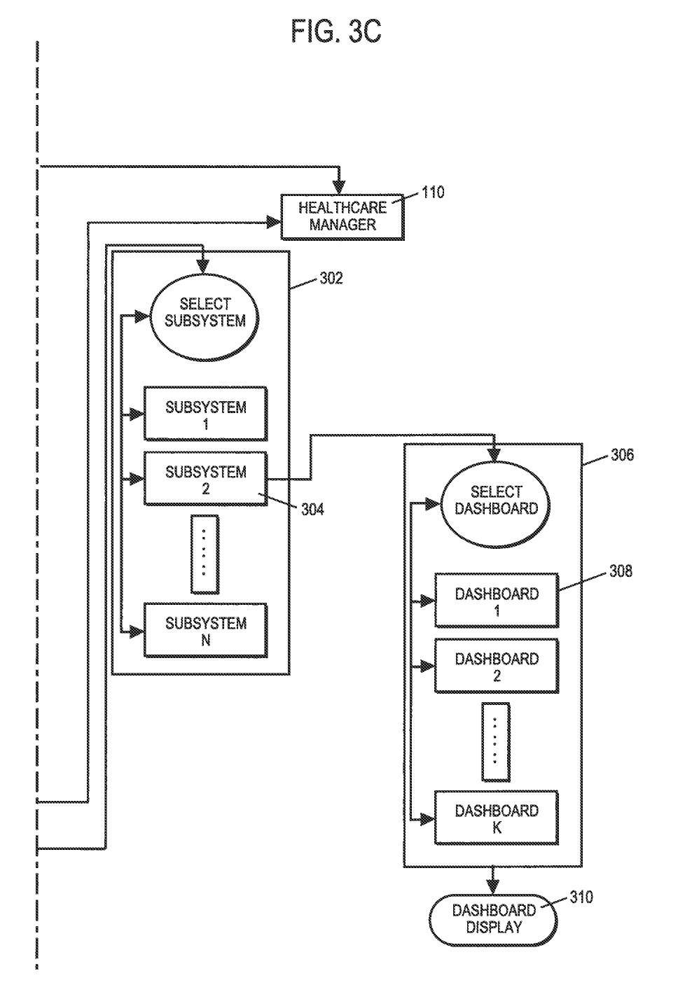

FIG. 3 elaborates the elements of FIG. 2 in one embodiment of the present invention as a Web-based service implementation 105 for delivering Applicants' method to a Healthcare organization. A password verification protocol with privacy protection 102 is set up for the implementation, allowing entry into a Selector graphic user interface 104. The passwords are specific to user type for the implementation, with one or more Instance Administrators 106, members of the implementation who provide data input from the healthcare organization or its units 108, and one or more Healthcare Managers 110 who use the Applicants' method for adaptive management of the healthcare organization and its subsystems.

An Instance Administrator can set up the Adaptive Intervention Management Subsystem 220 so that it is customized to the healthcare settings of the implementation. Such customization includes determining Adaptive Cycle specifications for the implementation 114, selecting data acquisition parameters 116, selecting variables related to the Adaptive Cycle dimensions 118, and determining the relative weights for the variable values 120. In addition, an Instance Administrator would select sampling regimes for data collection 122, which then determine how the Data Acquisition Subsystem 210 will sample members of the implementation who input data.

In order to set Applicants' method for data interpretation, an Instance Administrator would select the Adaptive Cycle Interpretive Framework suitable for the implementation 124. Such selection would trigger authorization to the Data Collection Portal 130, which in turn would set additional parameters within the Data Acquisition Subsystem 210. Selecting the Adaptive Cycle Interpretive Framework also establishes the framework for Adaptive Cycle Data Analyses 134 and connects these analyses to the Adaptive Cycle Interpretive Framework 136 that will be used for interpretation by the implementation.

An Instance Administrator also would authorize access 126 to the Interpretive Dashboard Subsystem 230 in order for Healthcare Managers 110 for the implementation to select arenas for adaptive management within their healthcare organization or subsystem 302-308, view and interpret data analyses within the framework of the Adaptive Cycle 310, and so implement adaptive management activities.

FIG. 3 also shows the connections of the Data Acquisition Subsystem 210 to Data Input 108 as well as the elements of the DAS that allow selection of data entry for each of the dimensions of the Adaptive Cycle 202-209, the analysis of these data 134, data interpretation 136, and display of analyses and interpretations of analyses in the Interpretive Dashboard Subsystem 230.

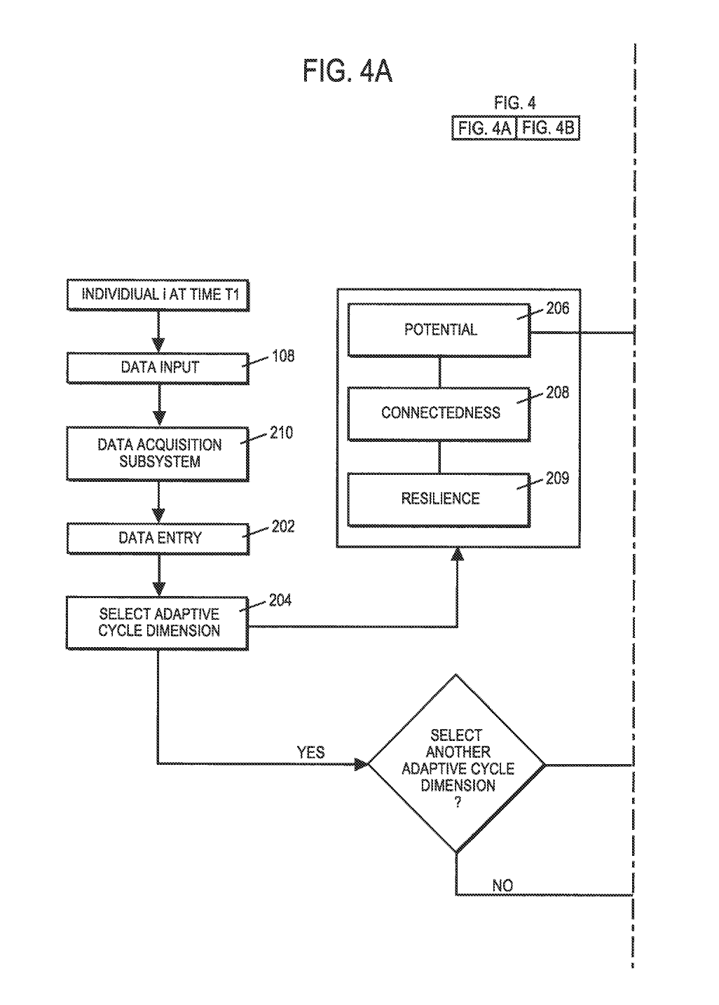

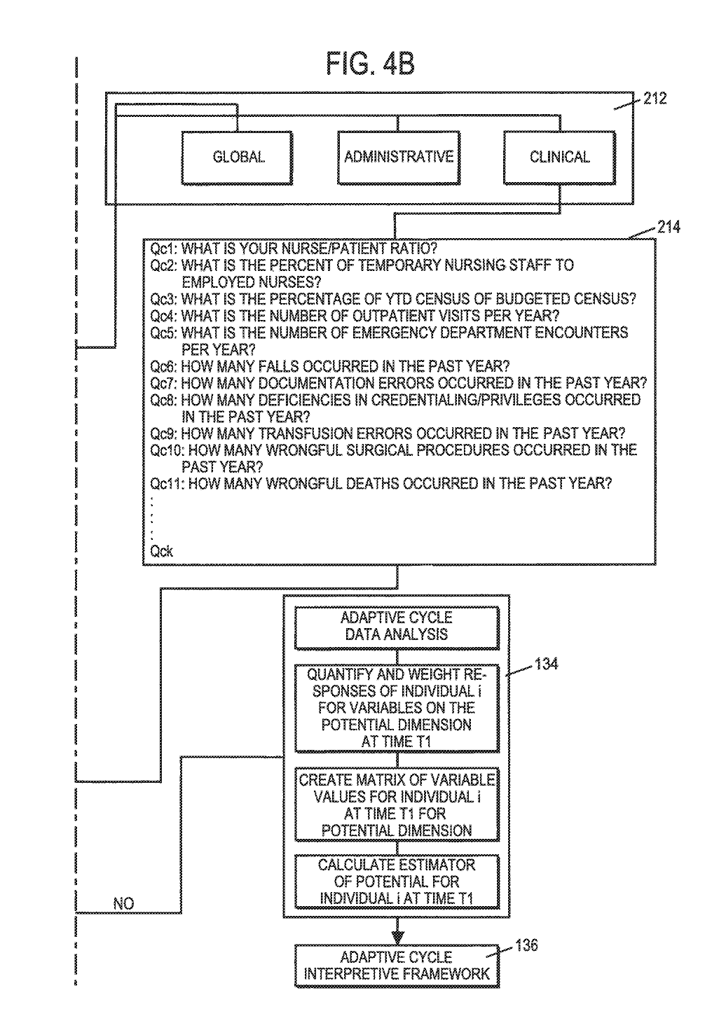

In FIG. 4, illustrates the DAS in more detail. The healthcare organization designates those personnel to be sampled. These individuals use a password for entry into the DAS, or to open links to data depositories, and the individual password identifies the subsystem in which the individual works or the data depositories are based. Applicants' method then allows an Individual, to enter a Data Input pathway 108 to the DAS 210 and begin data entry 202. Applicants' method prompts Individual, to select the pathway to enter data for each of the three dimensions of the Adaptive Cycle 204.

For example, in one embodiment of the invention by selecting the dimension of Potential 206, Individual, opens the data entry pathways for the variables of Potential wherein these variables are organized into three categories, Global, Administrative, and Clinical 212. Selecting one of these pathways opens specific data input tasks for Individual, to complete. FIG. 4 shows the Clinical category opened to a set of data input tasks here represented as a set of questions Q_{ci} 214, with i varying from 1 to k. Individual, completes data entry tasks for each Q_{ci} either by responding to the tasks as prompted or by loading data to the corresponding Q_{ci} from standard reports and other data repositories maintained by the healthcare organization.

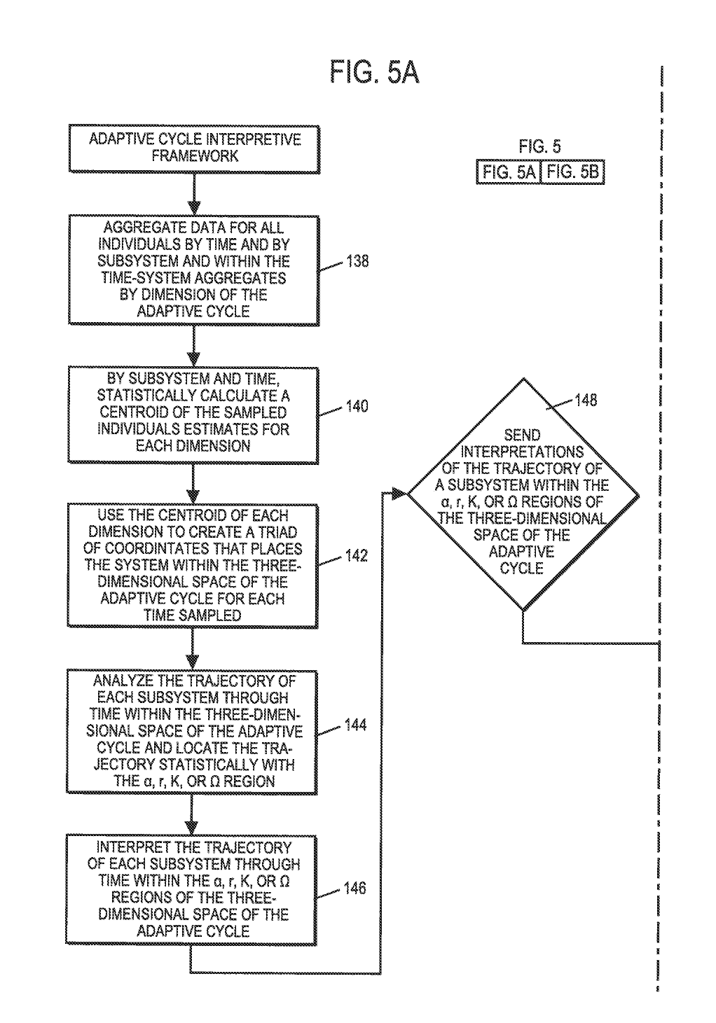

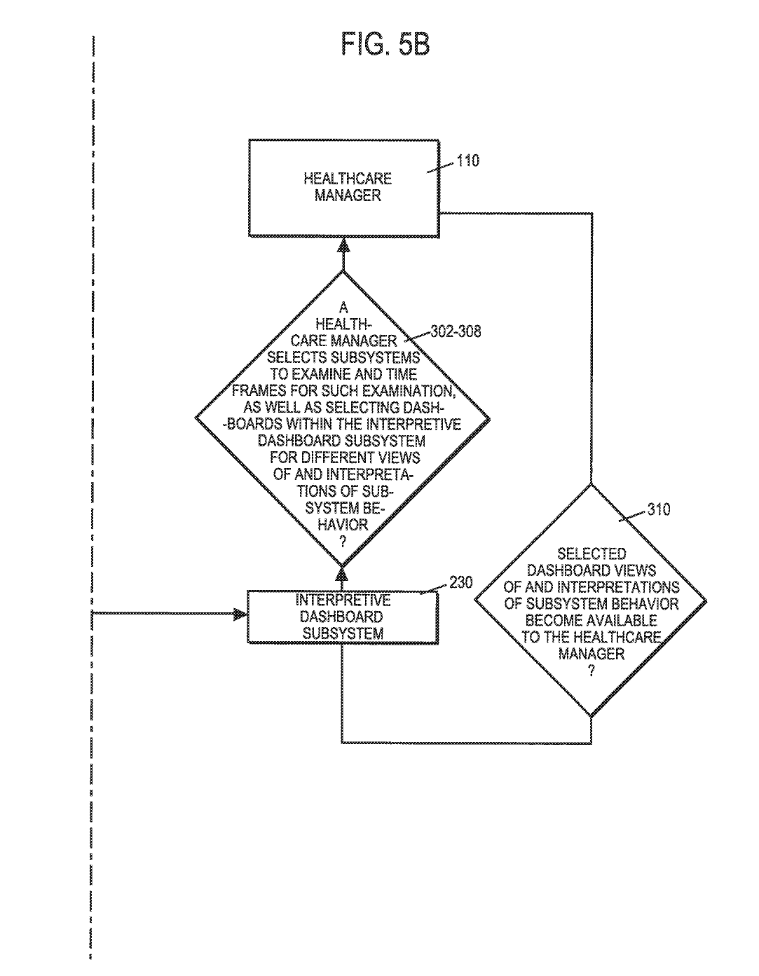

FIG. 4 further shows that once data entry is completed for all of the categories of variables for each dimension the data are analyzed within the Adaptive Cycle Data Analysis functionality 134. Data analyses are then linked to the Adaptive Cycle Interpretive Framework 136. FIG. 5 summarizes the functioning within the Adaptive Cycle Interpretive Framework 136. Data can aggregated in a variety of ways, but one embodiment of the system would aggregate data by Adaptive Cycle dimension by time and unit within the healthcare organization 138. Time-subsystem centroid values are computed for each of the dimensions of Applicants' Healthcare Adaptive Cycle 140.

Centroids are used for any time-subsystem analysis to create coordinates of a point within the three-dimensional space of the Adaptive cycle 142. The points for a healthcare organization or its subsystem represented by different times are analyzed as trajectories of stasis or change (improvement or deterioration) through the 3-dimensional space of the Adaptive Cycle 144. The trajectories are contextualized in their position and direction within the regions of K, Ω, α, and r as well as areas of transition from one of these regions to another 146. Interpretations are sent 148 to the Interpretive Dashboard Subsystem 300. Healthcare Managers 110 can select the entire healthcare organization or some of its subsystems for examination 302-308 (FIG. 3) and selected dashboards are provided for display 310.

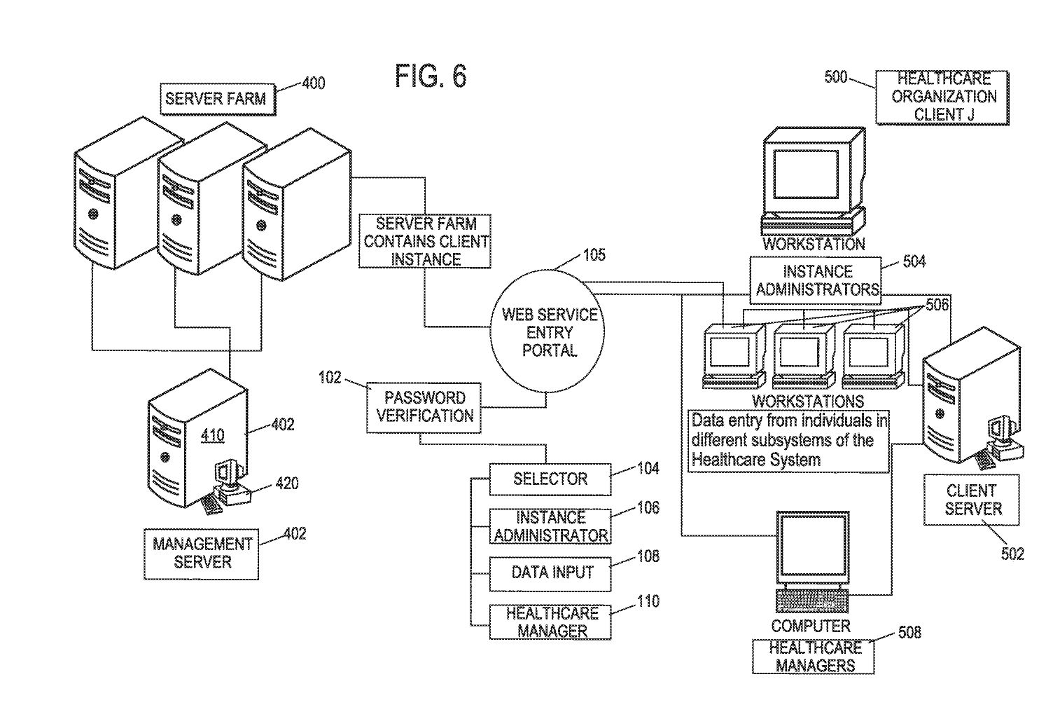

FIG. 6 shows one preferred embodiment of the invention as a Web-based service nested within an Applicants' Server Farm 400. The Server Farm is managed by Management Server 402, which provides administrative capacities and establishment of specific implementations. FIG. 6 shows a specific implementation for Clientⱼ nested within the Applicants' method Server Farm 400 and deployed through a Web Service Entry Portal 105 (also shown in FIG. 3). On the client side, the Healthcare Organization (j) 500 has its own Client Server 502 (or servers) for its own information technology needs. The Client Server provides privacy layers that protect access sharing of information through the Applicants' method Web Service Entry Portal 105. A Password Verification system allows authorized users to enter their implementation of Applicants' method 102. The Password Verification system opens pathways to a Selector 104 of the respective implementation and provides access to the paths for the Instance Administrator 106, for Data Input 108, and for use by Healthcare Managers 110.

Two significant facets of the Applicants' invention comprise the improved efficiency of sampling, as well as the increased sampling, thereby enhancing both the breadth and depth of data collected and related to the complexities of temporal and spatial heterogeneity within a healthcare organization and its units. A third facet of the invention comprises the ability to map the position of a healthcare organization and its units through time within a three-dimensional space representing the regions and transition of Applicants' Healthcare Adaptive Cycle.

These facets become clear upon examination of the workflow using Applicants' method. First, a healthcare organization invokes an implementation of Applicants' method. The management stakeholders work with the Instance Administrator to set up the specifications for using Applicants' method as an adaptive intervention management tool. Objectives of management strategies are then mapped onto a configuration of Applicants' method. Based on this configuration, the Instance Administrator selects Adaptive Cycle specifications by using menu arrays to choose the most appropriate data acquisition parameters, variables and their weights to be included in data collection for Adaptive Cycle analyses, sampling regimes, the Adaptive Cycle Interpretive Framework to be used, and the interpretive dashboards to be activated. These selections then allow Applicants' method to configure the Data Acquisition Subsystem for data input and analyses and to configure the Interpretive Dashboard Subsystem for use by managers in the healthcare organization and its subsystems.

Second, the managers designate individuals as well as data depositories to be sampled. In a preferred embodiment of the invention, the method of the Data Acquisition Subsystem of the invention automatically notifies individuals or connects to data depositories that are to be sampled at a particular moment in time. Specific data input tasks are generated by Applicants' method. These data tasks and the sampling regime are set prior to sampling within the Adaptive Intervention Management Subsystem, which allows a healthcare organization's management stakeholders to select from the large pool of data collection tasks that the invention contains or to add new data collection tasks to Applicants' method.

Each individual or depository sampled results in data input allowing mapping of the position of the healthcare organization or its units within Applicants' Healthcare Adaptive Cycle. Since the password of the individual or the linkage to a data depository identifies the organization's unit in which that person works or depository is relevant, Applicants' method sorts data input by unit and collates these data for analyses within a unit as well as across organizational units.

The data tasks for the individuals who input data or the data streaming from data depositories in the healthcare organization's IT systems provides variable values for each of the three dimensions, Potential, Connectedness, and Resilience. In Tables 1-5, we show types of queries utilized by Applicants' method to evaluate system behaviors. These queries can be reduced to data tasks that are completed by individuals within each organizational unit. Applicants' method includes automated data streaming from healthcare organization information management systems and therefore, the data obtained comprises data input by individuals entering data in combination with streaming of data from databases or depositories. From either pathway, Applicants' method aggregates data into the dimension of Applicants' Healthcare Adaptive Cycle by source (individual or depository) by time of sampling by healthcare organizational unit.

The variables selected for a particular Adaptive Cycle dimension represent a variable cluster for that dimension at a particular time in a particular subsystem of the healthcare organization. The values of the variable in the cluster for a dimension are then reduced to a single value representing the value of the respective property for the individual completing the data tasks or for the subsystem streaming data to the Data Acquisition Subsystem at a particular moment in time. Applicants' method utilizes the weighting of variables selected by the healthcare organization management stakeholders, and set as specification by the Instance Administrator, to compute such a single, representative value.

From the entire data set for a particular sampling time for a particular implementation, Applicants' method reduces the variable clusters of each individual or data depository to a single value for Potential, a single value for Connectedness, and a single value for Resilience. This triad of coordinates for each individual or data depository can then be plotted in the three-dimensional space 100 (FIG. 1) defined by the Potential, Connectedness, and Resilience axes. The points of all individuals or data depositories are then analyzed as a data cloud and/or collapsed statistically to a centroid of all individuals or depositories sampled for the respective subsystem at the moment of time at which the sampling was conducted. The centroid within the three-dimensional space of Potential, Connectedness, and Resilience reveals the healthcare organization's or some level of an organization's or an organization unit's position relative to the K, Ω, α, and r regions of Applicants' Healthcare Adaptive Cycle (again, se FIG. 1).

Applicants' method then analyses the three computed, dimensional centroid values. Usually, healthcare organizations attempt to keep their systems in the K region of Applicants' Healthcare Adaptive Cycle, although many go through periods of collapse (Ω,), reorganization (α), growing though external variability (r), and achieving some level of consolidation, efficiency, and productivity (K). However, even when in the K region healthcare organizations seldom have sufficient data to know the location of their particular metastable equilibrium at any moment in time.

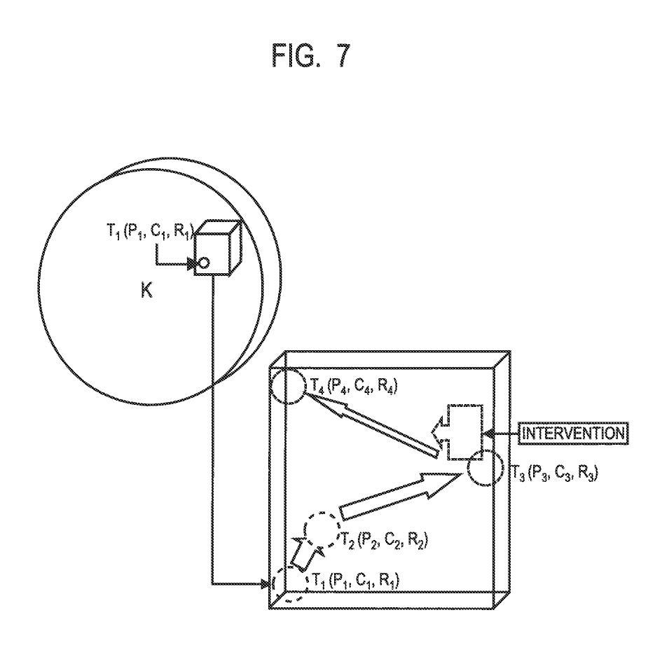

This point is illustrated diagrammatically in FIG. 7, which shows a position within K space at time T₁ and coordinates (P₁, C₁, R₁) in the three-dimensional space 100 (FIG. 1) of Potential, Connectedness, and Resilience. Even when evaluating a single unit of a healthcare organization located in one physical space within that healthcare organization, and thereby removing the effects of spatial heterogeneity, there remains temporal variability. FIG. 7 shows times T₂, T₃, and T₄, which represent a series of sampling times following time T₁. For each of these three times after T₁, FIG. 7 shows different locations within the K space. Therefore, FIG. 7 shows a dynamic whereunder the evaluated unit shifts over time to new positions in K space. This temporal variation may result from, for example, what happens on a Medical-Surgical floor that suddenly has considerable turnover in nursing staff that decreases Connectedness along with increases in stress of nursing staff that also decreases Resilience.

If healthcare organization's management decisions were based only on the unit's centroid values at time T₁, the changes and the implications of change through the subsequent time series of T₂-T₄ would not be either known or used. Systematic study of each moment in time, and examination of the variable clusters for Potential, Connectedness, and Resilience, allow the identification of variables that have changed in value and so are contributing to a shift. However, by implementing a judicious intervention Applicants' method can address the elements of an organizational unit that are reflected in the changing variables. The diagrammatic representation of an intervention at time T₃ is illustrated in FIG. 7. The intervention shifts the Potential, Connectedness, and Resilience towards a new position at time T₄.

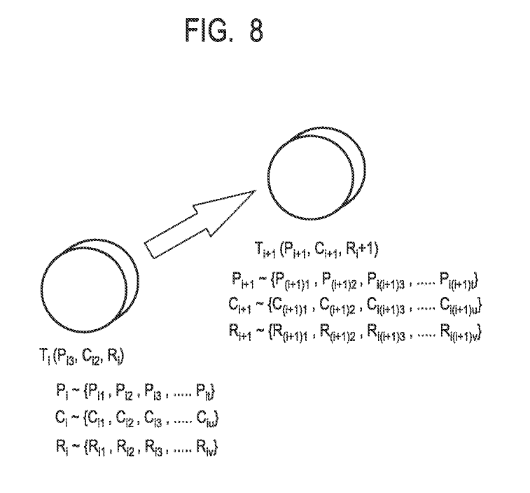

FIG. 8 illustrates variables and their respective values for two consecutive times, Tᵢ and Tᵢ₊₁. Applicants' method statistically combines the variables values for all individuals or depositories in a subsystem sampled at a particular time. These can then be shown as a central tendency for each variable across all individuals sampled. FIG. 8 shows the central tendencies of these variables as clusters for Potential, Connectedness, and Resilience, and shows that the single centroid values for the triad of coordinates at each time is estimated from the set of variables in the respective cluster. The management stakeholders of a healthcare organization can then evaluate the variables that have changed, and examine their likely causal contributions to any shifts that occurred in the time interval Tᵢ to Tᵢ₊ᵢ.

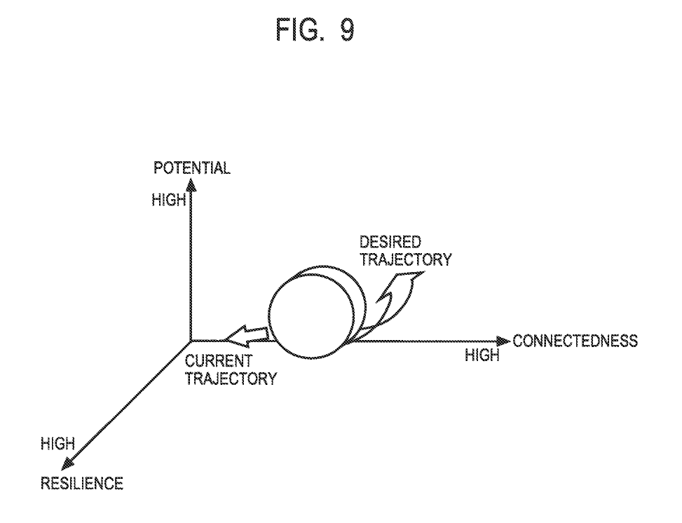

The arrow of FIG. 8 provides a vector that indicates the trajectory of system from Tᵢ to Tᵢ₊₁. This trajectory is the result of certain variables of the system changing through time. As an example, a low staff turnover, and so improved Connectedness, may be desired. FIG. 9 shows, however, that a current trajectory may not comprise a desired trajectory for the system. From the kind of microanalysis portrayed diagrammatically in FIGS. 7-9, Applicants' method determines where in Applicants' Healthcare Adaptive Cycle a system or subsystem is located at a point in time, and how the location of that system is changing through time.

In certain embodiments, Applicants' method visually displays the variables that are changing values from one moment in time to the next sampling. These changes can be shown systematically within each variable cluster. Again, Applicants' method analyzes across individuals to provide a central tendency for each variable.

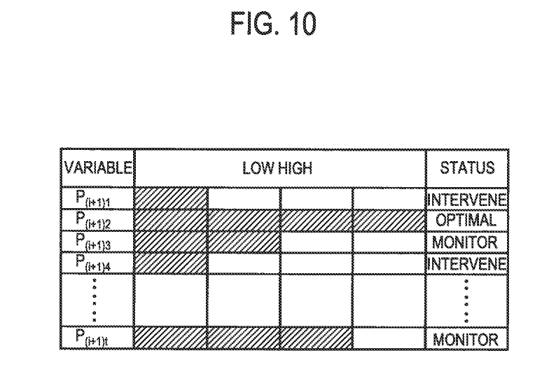

FIG. 10 shows a simple diagram of a dashboard, i.e. a visual display, that recites the centroid values, determined as of the time of sampling, for a plurality of variables along the Potential dimension. The dashboard in FIG. 10 recites a “Status” column that recommends whether unit managers should “Intervene,” “Monitor,” or perceive the variable value as within an “Optimum” range. Also note that the variables have been scaled from “Low” to “High,” wherein a “Low” status is assigned to variables whose values are destabilizing to the system, and a “High” status is assigned to those variables whose values are optimum for the system. Such analyses and interpretations are conducted within Applicants' method's Adaptive Cycle Data Analyses, and Adaptive Cycle Interpretive Frameworks, then displayed within the Interpretive Dashboard Subsystem.

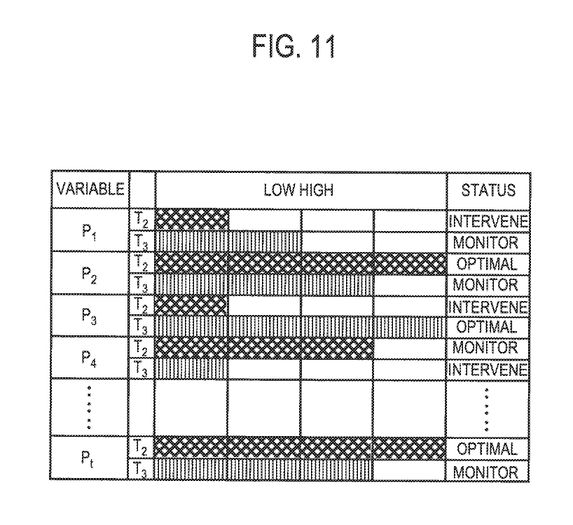

FIG. 11 shows a dashboard graphically depicting the centroid values of variables in the Potential variable cluster for two times, Tᵢ and Tᵢ₊₁. FIG. 11 designates two consecutive sampling times, T₂ and T₃. The change for each central tendency of a variable value is determined comparing the respective value at T₂ and the value at T₃.

In addition to providing sampling and analytical capacity for evaluating a single organizational unit through time, Applicants' method also allows simultaneous probes of temporal and spatial heterogeneity. That is, the sampling of individuals can be accomplished across as many of the organizational units as designated by the management stakeholders. The analyses also are chosen by the management stakeholders and the method allows analysis by individual units, by clusters of units, or by aggregating all data and providing an analysis of the entire organization. This capacity of Applicants' method can be visualized by thinking of FIGS. 7, 8, 9, 10 and 11, representing results from one organization unit, but that analogous figures are created by Applicants' method for any of the units or clusters of units in the healthcare organization.

In certain embodiments, Applicants' invention includes computer readable program code comprising instructions, such as instructions 410 (FIG. 6), residing in computer readable medium, wherein those instructions are executed by a processor, such as processor 420 (FIG. 6), to perform Applicants' method as described and claimed herein.

In other embodiments, Applicants' invention includes computer readable program code comprising instructions residing in any other computer program product, where those instructions are executed by a computer external to, or internal to, Applicants' server farm 400 (FIG. 6) or Management Server 402 (FIG. 6), to perform Applicants' method as described and claimed herein. In either case, the instructions may be encoded in an information storage medium comprising, for example, a magnetic information storage medium, an optical information storage medium, an electronic information storage medium, and the like. By “electronic storage media,” Applicants mean, for example and without limitation, one or more devices, such as and without limitation, a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method optimize the performance of a health care organization comprising a plurality of departments wherein each department comprises a plurality of individuals, comprising:
creating a 3-dimensional Healthcare Adaptive Cycle space defined by a Potential axis, a Connectedness axis, and a Resilience axis;
forming at a first evaluation time a first location for said healthcare organization within said Healthcare Adaptive Cycle;
visually displaying said 3-dimensional Healthcare Adaptive Cycle space and said first location.

2. The method of claim 1, wherein said forming comprises:
defining business goals for said organization;
defining clinical goals for said organization;
at a first evaluation time, comparing actual business results for said organization with business goals for that organization;
at said first evaluation time, comparing actual clinical results for said organization with clinical goals for that organization;
at said first evaluation time, creating for said organization a first evaluation time organization potential P1 based upon said comparing steps for that organization;
disposing said first location at a position P1 on said Potential axis.

3. The method of claim 2, wherein said forming further comprises:
at said first evaluation time, determining for said organization if a policy and procedure manual exists for that organization;
at said first evaluation time, determining for said organization if a newsletter exists for that organization;
at said first evaluation time, determining for said organization if that organization's business goals are reviewed and discussed with individuals within that organization;
at said first evaluation time, determining for said organization if that organization's clinical goals are reviewed and discussed with individuals within that organization;
at said first evaluation time, creating for said organization a first evaluation time organization connectedness C1 based upon said determining steps;
disposing said first location at a position C1 on said Connectedness axis.

4. The method of claim 2, wherein said forming further comprises:
at said first evaluation time, ascertaining for said organization a number of crises that have occurred during a last five year period;
at said first evaluation time, ascertaining for said organization an average crisis recovery time during the last five year period;
at said first evaluation time, ascertaining for said organization a number of organization CEOs during the last five year period;
creating for said organization a first evaluation time organization resilience R1 based upon said ascertaining steps;
wherein said first location is disposed at a position R1 on said Resilience axis.

5. The method of claim 4, wherein said creating an Adaptive Cycle Interpretive Framework comprises:
selecting data acquisition parameters;
selecting variables responsive to said data acquisition parameters to establish said first location on said Potential axis, on said Connectedness axis, and on said Resilience axis;
setting weights for each of said variables; and
selecting a sampling regime.

6. The method of claim 4, wherein said forming step further comprises:
generating data for each of said plurality of individuals, wherein said data is responsive to said data acquisition parameters;
calculating for said plurality of individuals a centroid data point for said first location on each of said Potential, Connectedness, and Resilience axes.

7. An article of manufacture comprising a non-transitory computer readable medium having computer readable program code disposed therein, said computer readable medium being usable with a computer processor to optimize the performance of a health care organization comprising a plurality of departments wherein each department comprises a plurality of individuals, the computer readable program code comprising a series of computer readable program steps to effect:
creating a 3-dimensional Healthcare Adaptive Cycle space defined by a Potential axis, a Connectedness axis, and a Resilience axis;
forming at a first evaluation time a first location for said healthcare organization within said Healthcare Adaptive Cycle;
visually displaying said 3-dimensional Healthcare Adaptive Cycle space and said first location.

8. The article of manufacture of claim 7, wherein the computer readable program code to form at a first evaluation time a first location for said healthcare organization within said Healthcare Adaptive Cycle further comprises computer readable program code comprising a series of computer readable program steps to effect:
retrieving pre-defined business goals for said organization;
retrieving pre-defined clinical goals for said organization;
at a first evaluation time, comparing actual business results for said organization with business goals for that organization;
at said first evaluation time, comparing actual clinical results for said organization with clinical goals for that organization;
at said first evaluation time, creating for said organization a first evaluation time organization potential P1 based upon said comparing steps for that organization
disposing said first location at a position P1 on said Potential axis.

9. The article of manufacture of claim 8, wherein the computer readable program code to form at a first evaluation time a first location for said healthcare organization within said Healthcare Adaptive Cycle further comprises computer readable program code comprising a series of computer readable program steps to effect:
at said first evaluation time, determining for said organization if a policy and procedure manual exists for that organization;
at said first evaluation time, determining for said organization if a newsletter exists for that organization;
at said first evaluation time, determining for said organization if that organization's business goals are reviewed and discussed with individuals within that organization;
at said first evaluation time, determining for said organization if that organization's clinical goals are reviewed and discussed with individuals within that organization;
at said first evaluation time, creating for said organization a first evaluation time organization connectedness C1 based upon said determining steps;
disposing said first location at a position C1 on said Connectedness axis.

10. The article of manufacture of claim 9, wherein the computer readable program code to form at a first evaluation time a first location for said healthcare organization within said Healthcare Adaptive Cycle further comprises computer readable program code comprising a series of computer readable program steps to effect:
at said first evaluation time, ascertaining for said organization a number of crises that have occurred during a last five year period;
at said first evaluation time, ascertaining for said organization an average crisis recovery time during the last five year period;
at said first evaluation time, ascertaining for said organization a number of organization CEOs during the last five year period;
creating for said organization a first evaluation time organization resilience R1 based upon said ascertaining steps;
disposing said first location at a position C1 on said Connectedness axis.

11. The article of manufacture of claim 10, wherein said computer readable program code to create an Adaptive Cycle Interpretive Framework further comprises computer readable program code comprising a series of computer readable program steps to effect:
selecting data acquisition parameters;
selecting variables responsive to said data acquisition parameters to establish said first location on said Potential axis, on said Connectedness axis, and on said Resilience axis;
setting weights for each of said variables; and
selecting a sampling regime.

12. The article of manufacture of claim 11, wherein said computer readable program code further comprises a series of computer readable program steps to effect:
generating data for each of said plurality of individuals, wherein said data is responsive to said data acquisition parameters;
calculating for said plurality of individuals a centroid data point for said first location on each of said Potential, Connectedness, and Resilience axes.

13. A computer program product encoded in a non-transitory computer readable medium wherein said computer program product is usable with a computer processor to assess the performance of a health care organization comprising a plurality of departments wherein each department comprises a plurality of individuals, comprising:
computer readable program code which causes said programmable computer processor to create a 3-dimensional Healthcare Adaptive Cycle space defined by a Potential axis, a Connectedness axis, and a Resilience axis;
computer readable program code which causes said programmable computer processor to form at a first evaluation time a first location for said healthcare organization within said Healthcare Adaptive Cycle;
computer readable program code which causes said programmable computer processor to visually displaying said 3-dimensional Healthcare Adaptive Cycle space and said first location.

14. The computer program product of claim 13, wherein the computer readable program code which causes said programmable computer processor to form at a first evaluation time a first location for said healthcare organization within said Healthcare Adaptive Cycle further comprises:
computer readable program code which causes said programmable computer processor to retrieve pre-defined business goals for said organization;
computer readable program code which causes said programmable computer processor to retrieve pre-defined clinical goals for said organization;
computer readable program code which causes said programmable computer processor to, at a first evaluation time, compare actual business results for said organization with business goals for that organization;
computer readable program code which causes said programmable computer processor to, at said first evaluation time, compare actual clinical results for said organization with clinical goals for that organization;
computer readable program code which causes said programmable computer processor to, at said first evaluation time, create for said organization a first evaluation time organization potential P1 based upon said comparing steps for that organization;
computer readable program code which causes said programmable computer processor to dispose said first location at a position P1 on said Potential axis.

15. The computer program product of claim 14, wherein the computer readable program code which causes said programmable computer processor to form at a first evaluation time a first location for said healthcare organization within said Healthcare Adaptive Cycle further comprises:
computer readable program code which causes said programmable computer processor to, at said first evaluation time, determine for said organization if a policy and procedure manual exists for that organization;
computer readable program code which causes said programmable computer processor to, at said first evaluation time, determine for said organization if a newsletter exists for that organization;
computer readable program code which causes said programmable computer processor to, at said first evaluation time, determine for said organization if that organization's business goals are reviewed and discussed with individuals within that organization;
computer readable program code which causes said programmable computer processor to, at said first evaluation time, determine for said organization if that organization's clinical goals are reviewed and discussed with individuals within that organization;
computer readable program code which causes said programmable computer processor to, at said first evaluation time, create for said organization a first evaluation time organization connectedness C1 based upon said determining steps;
computer readable program code which causes said programmable computer processor to dispose said first location at a position C1 on said Connectedness axis.

16. The computer program product of claim 15, wherein the computer readable program code which causes said programmable computer processor to form at a first evaluation time a first location for said healthcare organization within said Healthcare Adaptive Cycle further comprises:
computer readable program code which causes said programmable computer processor to, at said first evaluation time, ascertain for said organization a number of crises that have occurred during a last five year period;
computer readable program code which causes said programmable computer processor to, at said first evaluation time, ascertain for said organization an average crisis recovery time during the last five year period;
computer readable program code which causes said programmable computer processor, to at said first evaluation time, ascertain for said organization a number of organization CEOs during the last five year period;
computer readable program code which causes said programmable computer processor to create for said organization a first evaluation time organization resilience R1 based upon said ascertaining steps;
computer readable program code which causes said programmable computer processor to dispose said first location at a position R1 on said Resilience axis.

17. The computer program product of claim 16, wherein said computer readable program code to create an Adaptive Cycle Interpretive Framework further comprises:
computer readable program code which causes said programmable computer processor to select data acquisition parameters;
computer readable program code which causes said programmable computer processor to select variables responsive to said data acquisition parameters to establish said first location on said Potential axis, on said Connectedness axis, and on said Resilience axis;
computer readable program code which causes said programmable computer processor to set weights for each of said variables; and
computer readable program code which causes said programmable computer processor to select a sampling regime.

18. The article of manufacture of claim 11, further comprising:
computer readable program code which causes said programmable computer processor to generate data for each of said plurality of individuals, wherein said data is responsive to said data acquisition parameters;
computer readable program code which causes said programmable computer processor to calculate for said plurality of individuals a centroid data point for said first location on each of said Potential, Connectedness, and Resilience axes.
